(19) United States
(12) Patent Application Publication
(10) Pub. No.: US 2007/0243929 A1
(43) Pub. Date: Oct. 18, 2007

(54) Multiple gaming

(75) Inventors: Ronald S. Skotarczak, West Chester, PA (US); Seth Berger, Malvern, PA (US); Brian D. Haveson, Surf City, NJ (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: PokerMatic, Inc., Aston, PA (US)

(21) Appl. No.: 11/713,077

(22) Filed: Mar. 1, 2007

Related U.S. Application Data
(60) Provisional application No. 60/777,846, filed on Mar. 1, 2006.

(51) Int. Cl. A63F 13/00

(52) U.S. Cl. 463/31

(57) ABSTRACT

A method, system, and software is provided enabling a player, engaged in a game at an electronic gaming table, to request an additional hand, and/or request participation in another electronic game. A player can request additional hand or game; specifically selecting from an additional hand at the current table he/she is playing at (or home table), an additional hand at a remote table or a hand at a virtual table. It is also possible for system to automatically determine the most appropriate location for the additional hand and establish that proposed hand's location while presenting this as an option to the player. Establishment of the additional hands as part of the current table, another physical table, or a virtual table can be done based on optimization of the revenue for the gambling establishment.

### CROSS REFERENCE TO RELATED APPLICATION(S)

This application claims the benefit of the U.S. provisional application no. 60/777,846, filed on Mar. 1, 2006, which is incorporated here by reference as if fully set forth.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates to card games and more specifically, video enabled gaming tables and their gaming options, style, and application. Games of chance and gambling have held great interest to the masses for many centuries. Whether based on cards, dice, wheels or other objects or mechanical devices, participants have obtained tremendous pleasure by putting points or money at risk and participating in games that are a combination of skill and chance, or in some cases pure chance. With the advent or the electronic era, computing systems can now be employed to create and run games of chance.

Computer-based electronic games have existed for many years and have typically appeared as single user terminals with the computer acting as the “house.” More recently, electronic gaming tables have also been developed, including electronic poker tables in which a computer is used to run a game between the participants at the table. Internet gambling systems have also been developed in which users from various parts of the world can join in a virtual poker table and participate in a game for points or money, as dictated by appropriate local, state and international laws and regulations.

The general use of computers and electronic games has allowed individuals to develop multi-tasking skills which enable them to perform several tasks at once through simultaneous electronic user interfaces. For example, a significant percentage of the population surfs the Internet while watching television and users frequently have multiple windows open on a computer or use several screens to simultaneously check e-mail, surf and perform other tasks, such as word processing.

What is needed is a system which provides users with the ability to initiate and participate in multiple games from a single terminal and in particular, from a terminal located at an electronic gaming table.

### BRIEF SUMMARY OF THE INVENTION

Briefly stated, the present invention includes a method, system, and software enabling a player, engaged in a game at an electronic gaming table, can request an additional hand, and/or request participation in another electronic game. In one embodiment a player can request an additional hand or game; specifically selecting from an additional hand at the current table he/she is playing at (or home table), an additional hand at a remote table or a hand at a virtual table. In an alternate embodiment the system automatically determines the most appropriate location for the additional hand and establishes that proposed hand's location while presenting this as an option to the player. Establishment of the additional hands as part of the current table, another physical table, or a virtual table can be done based on optimization of the revenue for the gambling establishment. In a preferred embodiment, the gaming table is an electronic poker table and the additional hand is another hand of poker.

Once the additional hand has been requested and is established by the system, the user's display is partitioned into one or more sections to allow for the simultaneous playing of both hands. In some embodiments the user is allowed to play more than two hands and can play as many as can be supported by the display and by the limitations of the human response time, which in some instances is between four and eight hands.

In one embodiment, the number of simultaneous games the player is allowed to participate in depends on the types of games, such that a player may be limited to two hands of poker and two simultaneous blackjack games, but may not be permitted to play four simultaneous hands of poker. In some instances, the number and combination of games in which the player is permitted to participate may be determined by monitoring the house odds for each game and creating a combination of games or limits of games which optimizes revenue for the house. In one embodiment the system suggests games and additional hands to be played by the player, such that the player is enticed to play a combination of games which is beneficial to the house.

In an additional embodiment the user's financial status and in particular the amount of casino currency held by the player is monitored to control the number of games the player is allowed to participate in. In another embodiment, the rate at which the player is losing or winning money is monitored and the number of games the player is allowed to participate in is controlled by that rate of gain or loss.

The system can also monitor the playing history of a player and make suggestions for additional games to be played by the player which are likely to create an enhanced and more positive experience for that player. For example, if a player has been successful at poker during recent playing history in the casino, the system can suggest that the player play additional hands of poker while participating in a game at an electronic poker table. If a player has recently had significant or multiple losses at the poker table, this system can suggest alternative games, such as blackjack, which may evoke a more favorable response from the player. In one embodiment the system tracks the wins and losses of the player for each of the types of games available through the interface and picks a combination of games which are intended to elicit a positive response from the player based on his/her recent wins at those games.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the Drawings:

FIG. 1 illustrates a use case diagram for a multiple hand system;

FIG. 2 illustrates a use case diagram for an electronic table;

FIGS. 3A & 3B illustrate a class diagram for a player and a game with an association to a table, and a class diagram for the side games;

FIG. 4 illustrates a flow chart for the generation of an additional game/hand;

FIG. 5 illustrates the implementation of this system, including physical and virtual tables and possible non-table players;

FIG. 6A illustrates the basic user interface screen for a player to initially enter a game, in accordance with an embodiment of the present invention;

FIG. 6B illustrates the basic user interface screen for the home table hand, incorporating various functions to permit the user to participate in the local game are present, in accordance with an embodiment of the present invention;

FIG. 6C illustrates the betting screen used during game play for making additional bets, which screen contains both a keypad entry section and other betting options, in accordance with an embodiment of the present invention;

FIG. 6D illustrates the “last hand” screen used by players to review previous hands, in accordance with an embodiment of the present invention;

FIG. 6E illustrates the options menu screen for players for the user interface, in accordance with an embodiment of the present invention;

FIG. 6F illustrates the additional games and additional hands screen for players for the user interface, in accordance with an embodiment of the present invention;

FIG. 6G illustrates a split screen representation of a player participating in two hands at local or “home” table, in accordance with an embodiment of the present invention;

FIG. 6H illustrates a split screen representation of a player participating in two hands, one of which is being played at a remote table, in accordance with an embodiment of the present invention;

FIG. 6I illustrates a split screen representation of a player participating in multiple games, in this example “blackjack,” in accordance with an embodiment of the present invention; and

FIG. 6J illustrates the promotions and advertising screen located in the options menu from the user interface screen, in accordance with an embodiment of the present invention.

### DETAILED DESCRIPTION OF THE INVENTION

Certain terminology is used herein for convenience only and is not to be taken as a limitation on the present invention. In the drawings, like reference letters are employed for designating the like elements throughout the several figures.

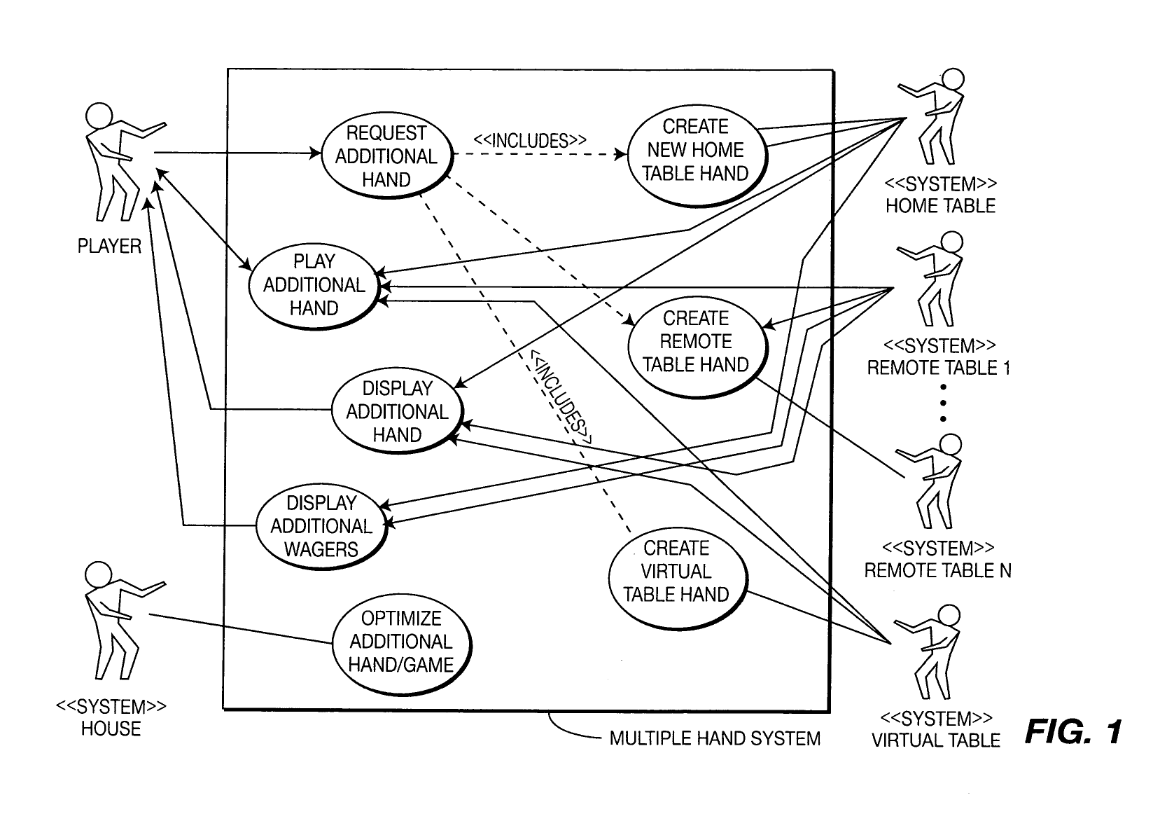

FIG. 1 illustrates a Unified Modeling Language (“UML”) use-case diagram for the Multiple Hand System and associated systems and actors in accordance with the present method and system. UML can be used to model and/or describe methods and systems and provide the basis for better understanding their functionality and internal operation as well as describing interfaces with external components, systems and people using standardized notation. When used herein, UML diagrams including, but not limited to, use case diagrams, class diagrams and activity diagrams, are meant to serve as an aid in describing the present method and system, but do not constrain its implementation to any particular hardware or software embodiments. Unless otherwise noted, the notation used with respect to the UML diagrams contained herein is consistent with the UML 2.0 specification or varjants thereof and is understood by those skilled in the art.

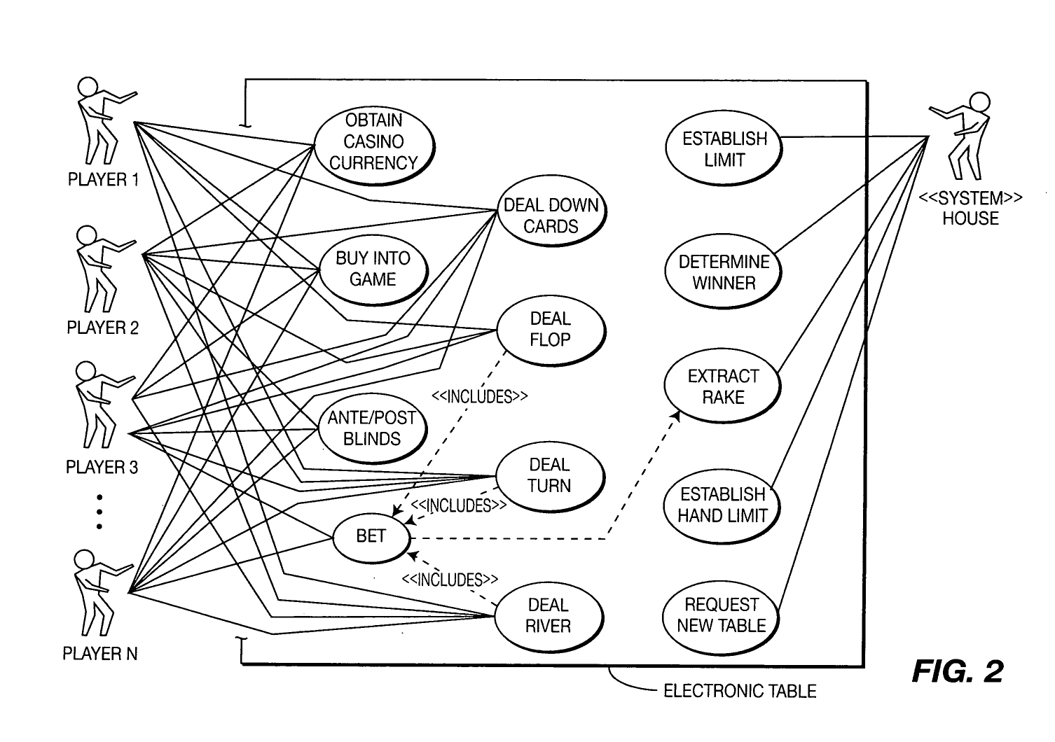

FIG. 2 illustrates a use case diagram for an electronic table in which a plurality of players participate in a game by evoking the “obtain casino currency” use case, a “buy into game” use case, an “ante/post blinds” use case, and a “bet” use case. The electronic table causes the playing of the game through evocation of a “deal down cards” use case, a “deal flop” use case, a “deal turn” use case, and a “deal river” use case. The “bet” use case is evoked appropriately through the dealing of the cards. The house, which in one embodiment is a computer or computing system which monitors the activities of one or more electronic tables, evokes an “establish limit” use case, a “determine winner” use case, an “extract rake” use case, an “establish hand limit” use case, and a “request new table” use case, such that the table is properly run within the constraints established by not only the house but by local, state and international regulation and law.

In one embodiment the house system not only establishes the playing parameters for the particular electronic table, but works in conjunction with the multiple hand system, to control which games and additional lands are offered to the player. In another embodiment the player is profiled and based on previous wins and losses, appropriate games are offered lo the player. In an additional embodiment, limits are established on the electronic table and other playing parameters are dictated by a the player's performance or financial standing, such that some players will not be offered an additional hand or will be offered additional hands or games with limited betting capabilities.

In another embodiment the player is profiled to create a player history in the multiple hand system, suggesting additional hands or games based on that player's wins or losses. In one embodiment the player's success at a particular game is used to suggest specific game(s) to the player and based on the player's losses in other games, those games are not suggested to the player.

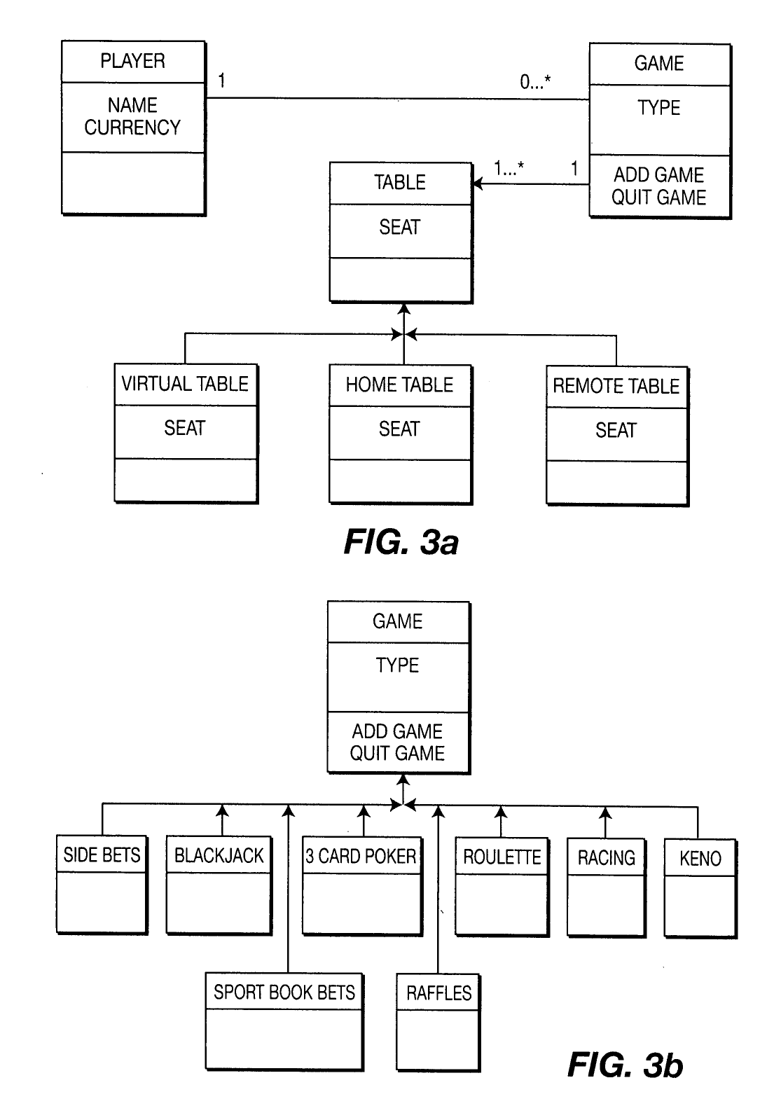

FIG. 3A illustrates a class diagram representing the class called “player” and its association with the class called “game” therein and the association of “game” to the general class called “table,” which can be comprised of a virtual table, a home table or a remote table. FIG. 3B illustrates the general class of game which can consist of games such as side bets, blackjack, three card poker, roulette, racing and keno. Other types of games can be included and may be incorporated into the system and offered for selection by the player. These games may comprise seats at a table or may simply be games of chance in which the individual plays against a machine, such as a slot machine game.

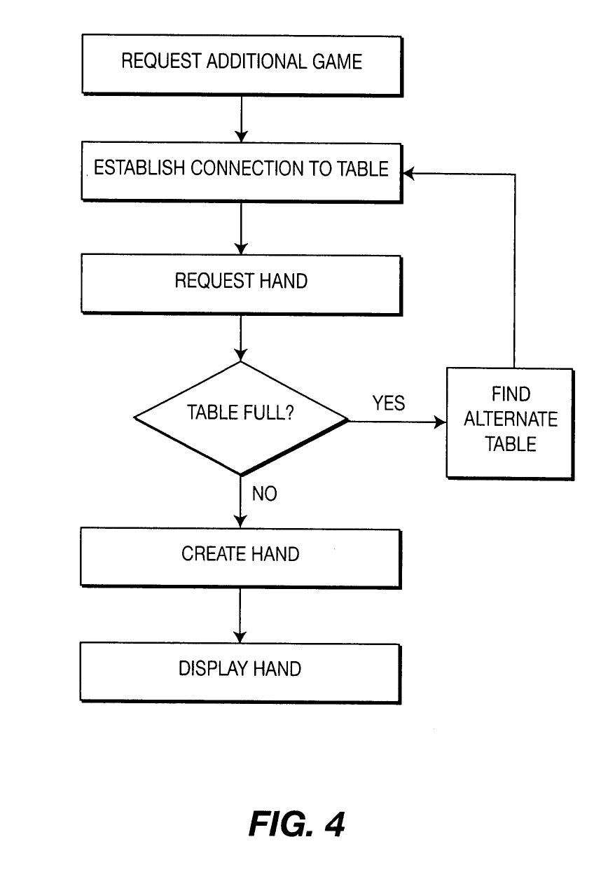

FIG. 4 illustrates a flow chart for the game, in which the user “requests an additional game” and the system then “establishes a connection to a table” and “requests a hand” to be dealt. In the event that table is full or no additional hand can be created, an alternate table is located through the “find alternate table” function. In the event that additional hand is possible, a “create hand” step takes place in which the player is logged on to the table and identified to the other players at the newly requested table. The player's display is subsequently modified to incorporate the display of the additional hand or game and the play of the second hand/game commences.

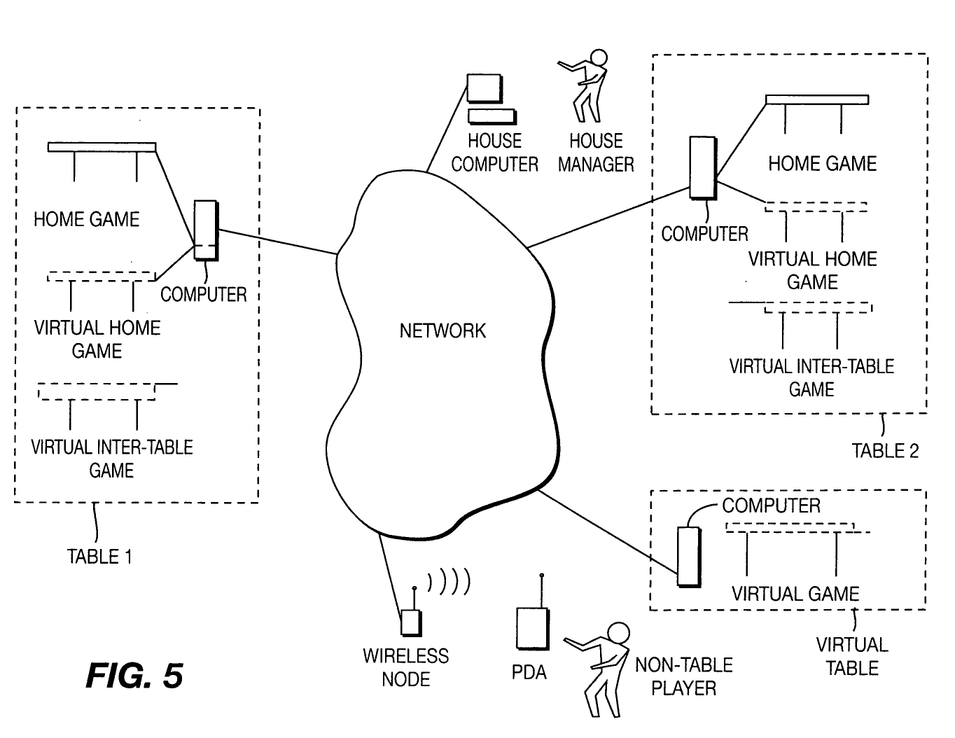

FIG. 5 illustrates implementation of the multiple hand system in which house computers host electronic table games and contain software comprising the multiple hand systems, which facilitate communication between tables and provide for the establishment of additional hands/games. In one embodiment the multiple hand system of FIG. 1 is implemented as distributed software, operating on the computers at the various tables. In an alternate embodiment, the multiple hand system of FIG. 1 is deployed on the house computer, which controls the establishment of additional hands on the actual tables. An action initiated by a player at a particular table (e.g. Table 1), can then request an additional hand. The multiple hand system, whether in a distributed form or located on the house computer, then determines whether the player has requested additional hands at the home game, on a virtual home game table or on a virtual intertable game. In one embodiment, the user is allowed to select the type of additional hand/games, while in an alternate embodiment the multiple hand system selects the type of game/hand for the user.

Based on the type of additional hand to be created, the system then logs the player on to the appropriate game and creates the additional hand. As previously described, the house, represented as “house computer and manager” in FIG. 5, can seek to optimize the types of hands/games presented to the player and can suggest the hands/games based on the player's previous performance. In one embodiment the house computer controls the offering of all games to all tables, while in an alternate embodiment the computers located at the individual tables, whether physical or virtual, manage the offerings to the players. Once the additional hand/game has been established, the display of that particular player is suitably modified and the player plays the games as usual.

As illustrated in FIG. 5, non-table players can also participate through the use of portable computing devices such as personal digital assistants, which can be wirelessly connected to the network, and thereby, to one of the physical or virtual tables or a remote gaming device, such as a slot machine. As an example, a player in the casino can participate in an actual game although not physically present. Alternatively, he/she can logon to a virtual game and play with other players, which are either at tables playing simultaneous physical and virtual games or located elsewhere in the casino using other handheld devices. In one embodiment, players access real and virtual games through computers located in their rooms, which are considered to be within the casino premises. An advantage of this embodiment is that players can continue their playing while not in the main gambling area of the casino and can participate in real or virtual games while in their rooms, thus increasing revenue for the casino.

Although the system, method and software have been described with respect to additional hands/games, tournaments can be played, either within a table within an establishment or between establishments, based on the ability to play multiple hands from one seat. As an example, a player may play multiple hands within a tournament, with the tournament being played on the home table, a remote table, or a virtual table, with the tables being located within the establishment or remotely. By playing multiple hands simultaneously, the play can increase their chances of staying in or winning the tournament.

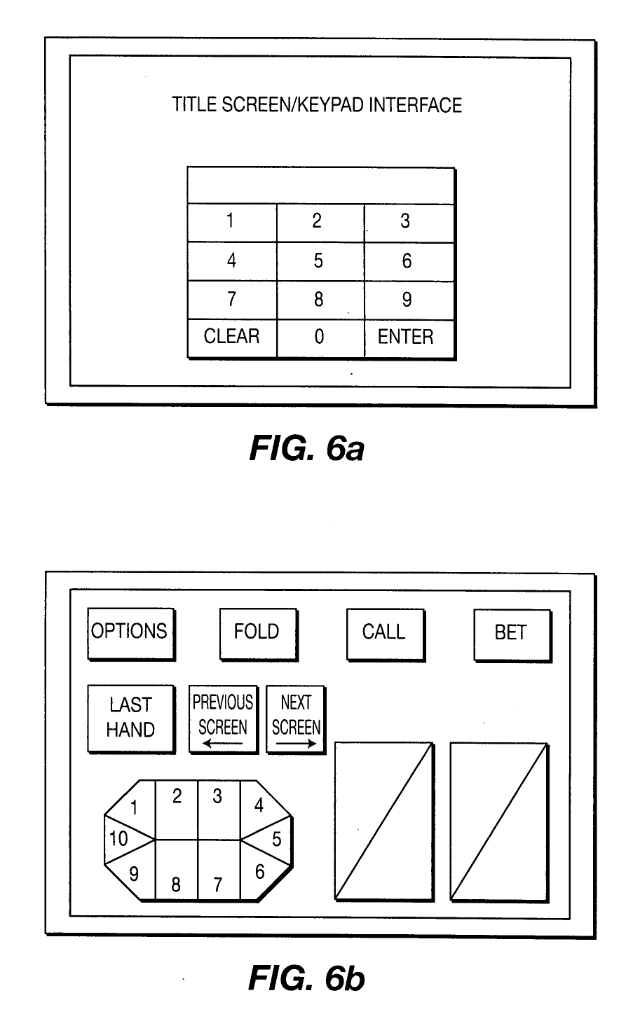

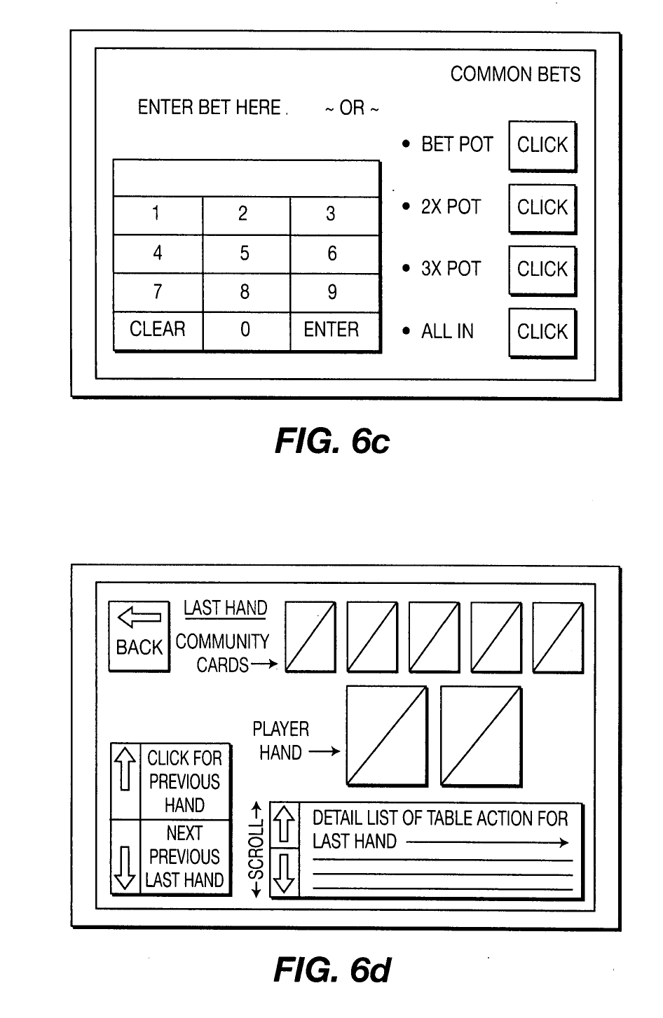

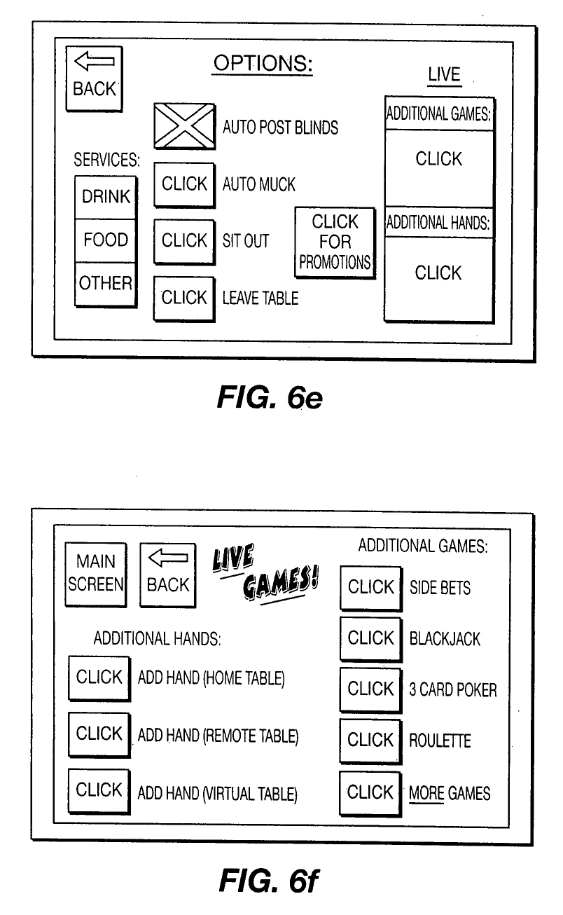

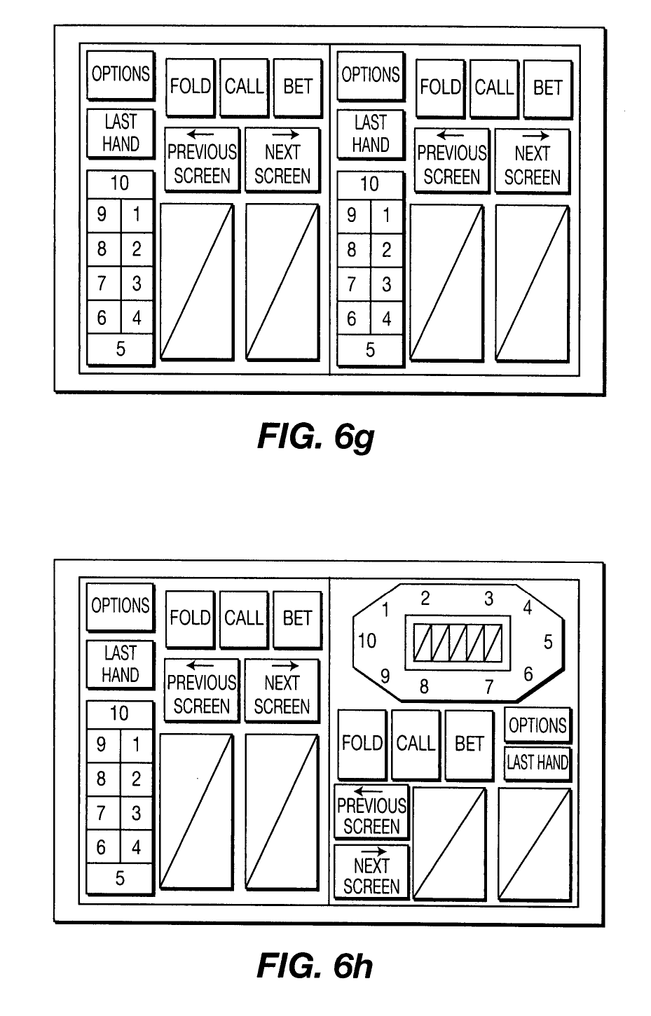

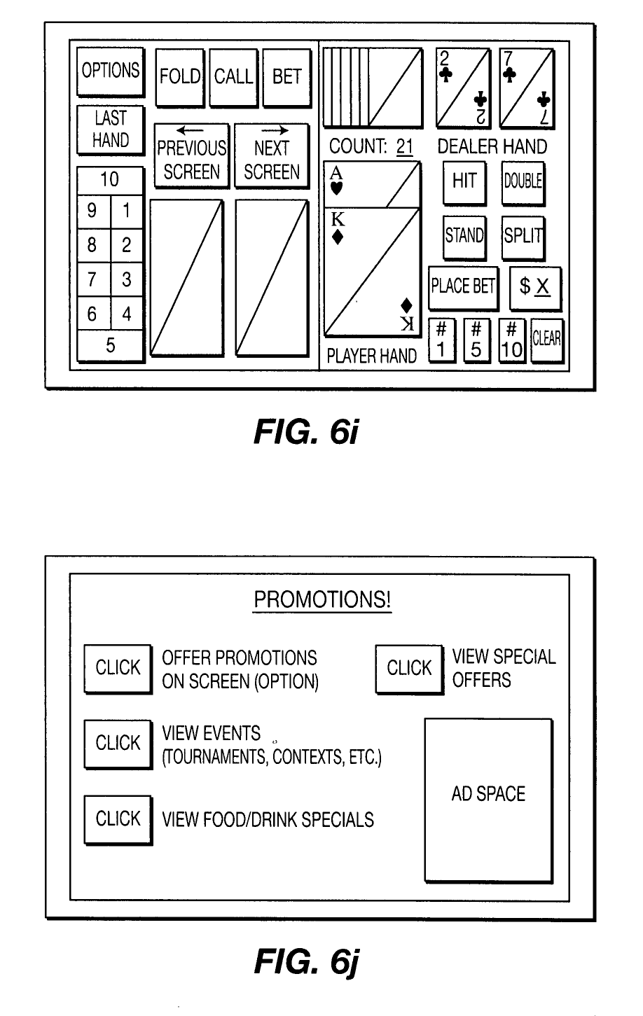

FIG. 6A illustrates the basic user interface screen a player is greeted with upon sitting down at a table, prompting their identification information to log into the table to enter a game. Preferred embodiments would include a graphical touch-sensitive keypad where users would enter their login information as well as check any account information before beginning to play at the table.

FIG. 6B illustrates the basic user interface screen for the home table hand. This screen incorporates various functions thereby permitting the user to participate in the local game as well as providing additional option menus to expand the number of hands and games the user is currently playing. Additional embodiments could include buttons for screen navigation, reviewing previous hands played during that current session of gaming, as well as graphical representations of the table “action,” wherein the other players' positions at the table, chip counts and other information could be displayed.

FIG. 6C illustrates the betting screen used during game play. In particular, it contains both a keypad (i.e. touch screen) entry section for specific bet amounts as well as common bet options. This feature is both useful for novice gamblers and also aids in speeding up game play for more experienced players. Preferred embodiments would include making the keypad entry area much like the opening user screen, with touch-sensitive buttons for fast data entry to increase the speed of game play.

FIG. 6D illustrates a “last hand” screen that can be used by players to review previous hands. This feature contains both graphical and text information related to previous hands and provides the player with the ability to review all the hands played during the current game. The invention permits this feature to only be invoked in situations where the particular game permits such review. As an additional embodiment, users could also access the information related to any previous hands played in “side” games, if the user had participated in additional hands or games during game play, again provided that the specific game in question allows users to review previous hands.

FIG. 6E illustrates the options menu screen for players, which contains several important aspects for game play, such as “auto post blinds,” “auto muck,” “sit out hand,” and “leave table” features, as well as the ability to add additional hands and/or games, the ability to order a host of services from the user terminal (food, beverages or other services) and the ability to view promotional information provided by the “house” or table operator. For example, the services offered at the terminal can include; the ability to reserve/book a room at a hotel, order show tickets, reserve seating at a restaurant or make other reservations, or arrange transportation. In one embodiment, a browser window is provided to allow the user internet access such that they can order services and products online. In an alternate embodiment, services and products are offered bough a proprietary interface located in a window or superimposed on the screen.

FIG. 6F illustrates the additional games and additional hands screen for players, which contains the user's ability to select additional hands from local, remote or virtual tables, as well as additional games such as blackjack, roulette or other table games to be played in a virtual setting. At the house's discretion, the additional games could be tailored to each user's individual profile, prompting games of interest to these specific players. As an additional embodiment, if the user is having more or less luck with a specific side-game, the system would recognize this trend and recommend a similar or drastically different game to the user, depending on their current success and available funds.

FIG. 6G illustrates a split screen representation of a player participating in two hands of poker at the local or “home” table, wherein the screen dedicates equal space for each game being played and allows users the exact same options are provided by as a single screen.

FIG. 6H illustrates a split screen representation of a player participating in two hands of poker, one of which is being played at a remote table, wherein the remote game includes a graphical representation of the table, the action therein, as well as the players at the remote table and their positions, as well as any needed options for standard game play.

FIG. 6I illustrates a split screen representation of a player participating in multiple games, in this example “blackjack,” wherein the player has the needed functionality on one side screen to play poker and the needed functionality on the other side screen to play the other selected game of choice.

FIG. 6J illustrates the promotions and advertising screen located in the options menu from the user interface screen, wherein players can view and participate in contests, events, specific offerings or specials, as well as other promotional related opportunities presented therein. As a preferred embodiment, a portion of this screen could be used to display graphical advertisements or streaming video, all promotion related, to generate more revenue for the house or table operator. An additional embodiment would include an “opt in” option for promotions to be displayed “on-screen” during game play, in selected areas on the user interface. This option could be set to “opt out” by default but could be changed manually, if the user so desires.

The present invention may be implemented with any combination of hardware and software. If implemented as a computer-implemented apparatus, the present invention is implemented using means for performing all of the steps and functions described above.

The present invention can be included in an article of manufacture (e.g. one or more computer program products) having, for instance, computer useable media. The media has embodied therein, for instance, computer readable program code means for providing and facilitating the mechanisms of the present invention. The article of manufacture can be included as part of a computer system or sold separately.

Although the description above contains many specific examples, these should not be construed as limiting the scope of the invention but as merely providing illustrations of some of the presently preferred embodiments of this invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. A method for using a multiple hand system comprising a home table, at least one remote table, a virtual table and a house;
said method comprising:
a) creating an additional hand at one of said home, remote and virtual tables responsive to a player's request;
b) displaying the additional hand on a player's display responsive to the additional hand created at said one of said home, remote and virtual table; and
c) displaying additional users at the player's display.

2. The method of claim 1, further comprising:
said house determining the table selected at step (a) based on criteria established at the house.

3. The method of claim 1, wherein the criteria employed by the house comprises:
the win and loss rates of the player.

4. The method of claim 1, wherein the criteria employed by the house comprises:
the currency available to said player.

5. The method of claim 1, wherein the criteria employed by the house comprises:
the games presently being played by said player.

6. The method of claim 1, wherein the house monitors all of said tables to:
determine table limits at a table.

7. The method of claim 1, wherein the house monitors all of said tables to:
determine limits for said player.

8. The method of claim 1, wherein the house monitors all of said tables to:
select an alternative table when a requested table is not available.

9. The method of claim 1, further comprising the player:
communicating with the table system through a wireless device.

10. The method of claim 1, further comprising the house:
limiting a communication range to players through limits of the table system.

11. The method of claim 1, further comprising the house limits of the table system recommending a variety of games based on the player's history compiled by the house.

12. The method of claim 1, further comprising the house:
creating a tournament and admitting the player to the tournament.

13. The method of claim 12, further comprising the house creating the tournament at any one of the available tables.
